(19) United States
(12) Patent Application Publication
(10) Pub. No.: US 2022/0138680 A1
(43) Pub. Date: May 5, 2022

(54) ORDER AGGREGATION SOFTWARE APPLICATION AND METHOD

(71) Applicant: Johnathon Francis Corcoran, Nanaimo (CA)

(72) Inventor: Johnathon Francis Corcoran, Nanaimo (CA)

(21) Appl. No.: 17/084,586

(22) Filed: Oct. 29, 2020

(51) Int. Cl. G06Q 10/08; G06Q 10/04; G01C 21/34; G01C 21/36

(52) U.S. Cl. CPC G06Q 10/0838; G06Q 10/0833; G01C 21/3617; G01C 21/3492; G01C 21/3484; G06Q 10/04

(57) ABSTRACT

A method operable to aggregate orders from a plurality of alternate sources wherein the orders require delivery of a good and wherein the present invention provides a correlation analysis of order evaluation parameters so as to suggest to a user of the software application of the present invention which orders to accept. The present invention is operated via a software application interface on a portable computing device. The software application of the present invention is communicably coupled to alternate applications that provide delivery service of a good such as but not limited to food. The present invention receives information about the orders available for delivery from the alternate applications and executes a correlation analysis based on a set of order evaluation parameters. After an analysis is performed a user is provided suggestions on which orders to take in combination.

### FIELD OF THE INVENTION

The present invention relates generally to delivery ordering software, more specifically but not by way of limitation, a software that facilitates a method of aggregating at least two alternate software ordering applications wherein the software of the present invention provides delivery drivers a method to receive and make a correlated evaluation of orders form the alternate software applications to promote coordinated delivery

### BACKGROUND

Thousands of people every day now order various items such as food from restaurants and groceries online to be delivered to their home. These services are quite popular in major metropolitan areas and numerous software applications are available to the consumers. Software applications and services like Skip The Dishes and Door Dash provide ordering availability for numerous different restaurants. As is known in the art, users of the aforementioned software applications and those similar thereto will order the desired items directly from the application to be delivered to their home or desired location. Delivery drivers are independently employed for these services and are responsible for receiving the initial order information, traversing to the restaurant to pick up the order and then delivering the order to the destination address. These drivers will typically sign into the software applications and make themselves available for delivering of goods over a certain period of time.

One issue that delivery drivers currently face is when they are actively available for more than one delivery application service. Many drivers in order to maximize their income potential during a certain time period will sign in to more than one delivery service application. This presents several challenges to the drivers, restaurants and operators of the delivery software application. The incoming order while in the same metropolitan area can be from restaurants that are not geographically proximate. Additionally, these orders may have required delivery times that can be difficult for a driver to achieve. Furthermore, different delivery services pay different rates and as such drivers may choose based solely on monetary value of the order, which can result in orders from other software application delivery services being late in delivery resulting in dissatisfaction from both the restaurant provider and the customer.

It is intended within the scope of the present invention to provide a delivery software application and method that is operable to provide aggregation of orders from alternate delivery software applications and provide a method of correlating based on a plurality of parameters in order to provide efficient selection of orders for a delivery driver.

### SUMMARY OF THE INVENTION

It is the object of the present invention to provide a software application configured to execute a method of aggregating delivery orders for a delivery driver from multiple delivery services wherein the present invention is operably coupled to multiple alternate delivery services software applications.

Another object of the present invention is to provide a method for aggregating and correlating delivery orders from multiple sources wherein correlation is executed to optimize delivery efficiency selections for a user of the present invention wherein the present invention evaluates geographic relationships between a driver, a provider and a delivery destination.

A further object of the present invention is to provide a software application configured to execute a method of aggregating delivery orders for a delivery driver from multiple delivery services wherein the present invention is operably coupled with alternate software application deliver services during the account initialization process.

Still another object of the present invention is to provide a method for aggregating and correlating delivery orders from multiple sources wherein correlation is executed to optimize delivery efficiency selections for a user of the present invention wherein the present invention further includes the parameter of delivery time requirement during the order evaluation procedure.

An additional object of the present invention is to provide a software application configured to execute a method of aggregating delivery orders for a delivery driver from multiple delivery services wherein the present invention further includes the step of analyzing the payment amount of an order during the order evaluation process.

Yet a further object of the present invention is to provide a method for aggregating and correlating delivery orders from multiple sources wherein correlation is executed to optimize delivery efficiency selections for a user of the present invention wherein the software application of the present invention has a user interface suitable for a smart phone.

Another object of the present invention is to provide a software application configured to execute a method of aggregating delivery orders for a delivery driver from multiple delivery services wherein the method of the present invention further includes the step of evaluating the delivery destination geographic location.

An alternate object of the present invention is to provide a method for aggregating and correlating delivery orders from multiple sources wherein correlation is executed to optimize delivery efficiency selections for a user of the present invention wherein the method of the present invention is focused on improving customer satisfaction for both providers and receivers of delivered goods.

An alternative objective of the present invention is to provide a software application configured to execute a method of aggregating delivery orders for a delivery driver from multiple delivery services wherein the software application of the present invention will provide order suggestions for the user to accept ensuing evaluation of the order parameters.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of the method of the present invention facilitated by the software application.

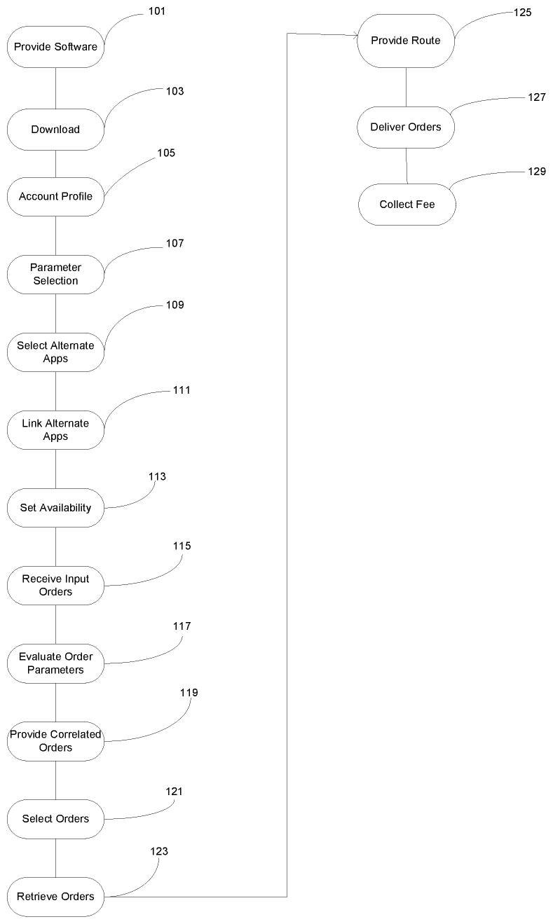

### DETAILED DESCRIPTION

References now to the drawings submitted herewith, wherein various elements depicted therein are not necessarily drawn to scale and wherein through the views and figures like elements are referenced with identical reference numerals, there is illustrated an order aggregation method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Drawings submitted as a part hereof, the order aggregation method 100 is focused on providing optimization of delivery orders from at least two different sources wherein the different sources are input into the order aggregation method 100, evaluated and subsequently at least two orders are provided to the user of the order aggregation method 100. In step 101 of the order aggregation method 100, the operator of the order aggregation method 100 will provide the software application operating the method of the present invention to users. It should be understood within the scope of the present invention that the software application is published to the Internet and made available utilizing conventionally available services and equipment such as but not limited to computers and software application stores. In step 103, a user will download the software application of the present invention onto a suitable portable computing device such as but not limited to a smart phone. Step 105, the user will establish an account profile with the order aggregation method 100 wherein this is to include but not be limited to user name, drivers license information and bank account information for payment transfer.

In step 107, the software application will provide to the user a selection of parameters that will be utilized in correlation analysis for delivery of orders. These parameters will be utilized to screen each available order so as to provide to the user of the order aggregation method 100 more than one order that can be efficiently received and delivered by the user of the order aggregation method 100. In a preferred embodiment of the present invention the parameter selection will at least include the following: geographic location of the user, geographic location of the restaurant (or goods provider), geographic location of the destination, delivery time requirement, traffic conditions and payment amount. It should be understood within the scope of the present invention that the aforementioned parameters are exemplary only and do not serve to exclude additional parameters. Ensuing selection of the order parameters in step 109 the user of the order aggregation method 100 will select which alternate software applications from which the user would like to receive orders into the order aggregation method 100. It should be understood within the scope of the present invention that the user will select at least two alternate software applications wherein the expectation is for the user to activate their availability with at least two software delivery applications at the same time and receive order inputs from both for evaluation by the software of the order aggregation method 100. In step 111, the user will link the at least two selected alternate software delivery applications with the software application of the order aggregation method 100.

Step 113, upon the desire of the user of the order aggregation method 100 to make available their services for delivery of goods, the user will utilize the software application to make themselves available for a time window of a day so as to be available to receive available order inputs from the alternate software delivery applications. It should also be further understood that the user of the order aggregation method 100 could select predetermined shift(s) for which the user can be available. In step 115, ensuing making themselves available in the software application of the present invention, the user of the order aggregation method 100 will begin to receive orders available for delivery. The orders provided to the user available for delivery are received from at least two alternate software delivery applications. In step 117, the software application of the present invention will execute a correlation analysis utilizing the aforementioned order parameters to identify more than one order that the user of the order aggregation method 100 can accept.

In step 119, the software application of the order aggregation method 100 will provide a list of the orders to the user wherein the list of orders comply with the order evaluation parameters. Step 121, the user of the order aggregation method 100 will select all or some of the orders presented to the user wherein once accepted the software application of the present invention transmits a notification to the alternate software delivery applications that the user has accepted the orders. In step 123, the user of the order aggregation method 100 will proceed to the origin locations of the items that are to be picked up for delivery and will retrieve the orders from the providers. Step 125, the software application of the present invention will provide an optimized route for delivery of the items based on parameters such as but not limited to current traffic conditions and geographic locations of each destination. In step 127, the user of the software application of the order aggregation method 100 will deliver the orders. Step 129, ensuing confirmation of the delivered order, a fee will be transferred to the user of the order aggregation method 100.

It should be understood within the scope of the present invention that while a preferred embodiment is to utilize the order aggregation method 100 for food delivery that the order aggregation method 100 could be utilized for any delivery of a good from multiple providers. Furthermore it should be understood the order aggregation method 100 could be used for ride sharing or other types of services. It should be further understood within the scope of the present invention that the order aggregation method 100 could be utilized to identify a solo order based on the evaluation parameters instead of multiple orders.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method operable to facilitate receipt of delivery orders from at least two alternate delivery order service providers wherein the method provides evaluation of orders so as to optimize order selection of a user of the method of the present invention comprising the steps of:
providing a software application to a plurality of users, wherein the software application is made available for download onto remote computing devices;
downloading the software application, wherein at least one user downloads the software application of the present invention;
creating an account, wherein the at least one user creates an account with an operator of the method utilizing the software application;
selecting at least two alternate delivery services, wherein the at least one user will select at least two alternate delivery services;
linking the software application with the at least two alternate delivery services;
providing a list of order evaluation parameters, wherein the order evaluation parameters will be utilized in suggesting orders to accept by the at least one user;
activating the at least one user's availability, wherein the at least one user of the software application makes themselves available to receive delivery order information;
receiving a plurality of available delivery orders, wherein the at least one user receives a plurality of orders available to be delivered;
evaluating the plurality of delivery orders, wherein the plurality of delivery orders are evaluated utilizing the order evaluation parameters;
selecting at least two orders; and
facilitating the delivery of the at least two orders.

2. The method operable to facilitate receipt of delivery orders from at least two alternate delivery order service providers as recited in claim 1, and further including the step of selecting order evaluation parameters, wherein the at least one user will select at least one order evaluation parameter provided.

3. The method operable to facilitate receipt of delivery orders from at least two alternate delivery order service providers as recited in claim 2, wherein the order evaluation parameters include geographic location of the at least one user.

4. The method operable to facilitate receipt of delivery orders from at least two alternate delivery order service providers as recited in claim 3, and further including the step of providing a correlation analysis of orders received utilizing the selected order evaluation parameters.

5. The method operable to facilitate receipt of delivery orders from at least two alternate delivery order service providers as recited in claim 4, wherein the order evaluation parameters include geographic location of a goods provider.

6. The method operable to facilitate receipt of delivery orders from at least two alternate delivery order service providers as recited in claim 5, wherein the order evaluation parameters include geographic location of a destination for an order.

7. The method operable to facilitate receipt of delivery orders from at least two alternate delivery order service providers as recited in claim 6, and further including the step of receiving a payment for delivery of an order, wherein the at least one user receives a payment for delivering an order.

8. The method operable to facilitate receipt of delivery orders from at least two alternate delivery order service providers as recited in claim 7, wherein the order evaluation parameters include a payment amount for which the at least one user will receive for delivery of the order.

9. A method operable optimize delivery of at least two orders received from different sources wherein the method provides evaluation of order parameters to suggest orders to be combined for delivery wherein the method comprises the steps of:
providing a software application to a plurality of users, wherein the software application is made available for download onto remote computing devices;
downloading the software application, wherein at least one user downloads the software application of the present invention;
creating an account, wherein the at least one user creates an account with an operator of the method utilizing the software application;
selecting alternate delivery services, wherein the at least one user of the software application will select alternate delivery services from which to receive order availability information;
coupling the software application with the alternate delivery services, wherein the software application is communicably coupled to alternate delivery services so as to receive order information therefrom;
providing a list of order evaluation parameters, wherein the order evaluation parameters will be utilized in suggesting orders to accept by the at least one user;
selecting a plurality of order evaluation parameters, wherein the at least one user will select order evaluation parameters wherein the order evaluation parameters are compared for correlation thereof to determine orders to suggest to the at least one user;
activating the at least one user's availability, wherein the at least one user of the software application makes themselves available to receive delivery order information;
receiving a plurality of available delivery orders, wherein the at least one user receives a plurality of orders available to be delivered;
correlating the plurality of delivery orders based on the order evaluation parameters, wherein the plurality of delivery orders are evaluated to determine which orders are most correlated based on the order evaluation parameters;
suggesting at least two orders, wherein at least two orders are suggested to accept for delivery by the at least one user;
selecting the at least two orders; and
facilitating the delivery of the at least two orders.

10. The method operable optimize delivery of at least two orders received from different sources as recited in claim 9, wherein the order evaluation parameters include geographic location of a goods provider.

11. The method operable optimize delivery of at least two orders received from different sources as recited in claim 10, and further including the step of receiving a payment for delivery of an order, wherein the at least one user receives a payment for delivering an order.

12. The method operable optimize delivery of at least two orders received from different sources as recited in claim 11, wherein the order evaluation parameters include geographic location of a destination for an order.

13. The method operable optimize delivery of at least two orders received from different sources as recited in claim 12, wherein the order evaluation parameters include geographic location of the at least one user.

14. The method operable optimize delivery of at least two orders received from different sources as recited in claim 13, wherein the order evaluation parameters include amount of a fee to be paid to the at least one user.
